(19) United States
(12) Patent Application Publication
(10) Pub. No.: US 2008/0315634 A1
(43) Pub. Date: Dec. 25, 2008

(54) Motor Vehicle Seat Provided with an Air Supply Device

(75) Inventors: Dietmar Hartmann, Jettingen (DE); Karl Pfahler, Stuttgart (DE); Lothar Renner, Nufringen (DE); Dirk Weisser, Ehningen (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLER AG, STUTTGART (DE)

(21) Appl. No.: 11/996,825

(22) PCT Filed: Jul. 21, 2006
(86) PCT No.: PCT/EP2006/007199

§ 371 Date: Jul. 7, 2008

(30) Foreign Application Priority Data
Jul. 27, 2005 (DE) 10 2005 035 115.8

(51) Int. Cl. B60N 2/56; B60H 1/00; H05B 3/00

(52) U.S. Cl. 297/180.14; 454/120; 297/452.47; 219/202

(57) ABSTRACT

A motor vehicle seat, in particular for an open motorcar, having an air supply device for supplying an air flow from an air output opening to the head, neck and shoulder area of a passenger. The air supply device includes a heating or cooling system for heating or cooling the air flow. This air supply device is a more efficient heating or cooling system for a motor vehicle seat. For this purpose, the air supply device comprises a sandwich that includes at least one heating or cooling layer and at least one air penetrable layer and a structure which makes it possible to convert the air flow into turbulent or diffused steam.

### BACKGROUND AND SUMMARY OF THE INVENTION

This application is a national stage of PCT International Application No. PCT/EP2006/007199, filed Jul. 21, 2006, which claims priority under 35 U.S.C. § 119 to German Patent Application No. 10 2005 035 115.8, filed Jul. 27, 2005, the disclosure of which is expressly incorporated by reference herein.

The invention relates to a motor vehicle seat, in particular for an open automobile, having an air supply device for supplying the head, neck and shoulder region of a seat occupant with an air current.

From DE 103 17 512 B3, an air supply device in a motor vehicle seat is known, in which an air outflow opening is provided on the side of the seat which is facing the seat occupant. A warm air current generated by a heating element can issue through this opening, for serving the head, neck and shoulder region of the seat occupant. In open travel, the air flowing over or around the windscreen creates a so-called air roll behind the vehicle seat, which leads to undesirable draft phenomena in the region of the head, neck and shoulder region of the seat occupant. In order to significantly minimize these draft phenomena, the warm air current generated by the air supply device is directed by means of a nozzle of the air outflow opening to the appropriate body region of the seat occupant. The warm air then flows around the seat occupant so as to achieve the desired warming of the head, neck and shoulder region.

The object of the present invention is to design an air supply device for a motor vehicle seat, of the type stated above, whose heating and/or cooling device has an improved efficiency.

According to the invention, the air supply device of the motor vehicle seat is equipped with a heating and/or cooling device, whose air-penetrable layer is provided with a structure with which the entering air current can be converted into a turbulent or diffuse flow. A turbulent or diffuse flow of this type has the advantage that it can absorb far more heat or cold than a laminar air current. Unlike a laminar flow in which the boundary layers in direct contact with the heating and/or cooling layer get warmed or cooled, in the present case, as a result of the diffuse distribution of the air current, a far greater air component gets warmed or cooled. In addition, the generated turbulent or diffuse flow remains within the air-penetrable layer longer, so that more heat or cold can be absorbed. As a result, compared to the prior art—given the constant heating output—a greater temperature difference between the inflowing and outflowing air can thereby be achieved.

The turbulent or diffuse flow of the air current is achieved by virtue of the structure of the air-penetrable layer having a multiplicity of spacer threads, webs, wires or the like. A conceivable design of this air-penetrable layer can be adopted as known, for example, from DE 198 05 178 C2, which relates to a spacer knitted fabric for use in a ventilated vehicle seat. The spacer knitted fabric there includes a multiplicity of spacer webs or threads, which run transversely to the outer broad sides of the spacer knitted fabric and a turbulent or diffuse air flow can flow around it. Here, the spacer webs or threads are mutually arranged in specific patterns, by which the flow direction and flow velocity can be influenced. In this context, it should be noted that the spacer webs or threads can have a wide variety of cross-sectional forms, such as, circular, oval, rectangular, square or the like. The spacer webs or threads can be aligned in mutually orientated or non-orientated arrangement and consist of a wide variety of materials. It has proved particularly advantageous to configure the spacer webs or threads as a knitted fabric, a woven fabric, or as a braided fabric. Nevertheless, it is conceivable, however, to dispose the spacer threads or webs in a non-orientated arrangement in the manner of a wool. It can be seen that such a knitted, woven or braided fabric has a very large circum flowed area for the delivery of heat/cold to the through-flowing air.

It has additionally proved particularly advantageous to make the structure of the air-penetrable layer from a well-conducting metal, for example, an aluminum or copper alloy. Metallic threads of this type are consequently particularly well suited to delivering heat or cold to the circum flowing air. The large circum flowed area of the multiplicity of spacer threads, wires or webs creates a very effective heating and/or cooling device.

The previously described structure of spacer webs, wires or threads additionally has the advantage that these can be of elastically flexible configuration. It is thereby possible to adapt the air-penetrable layer or the entire sandwich of heating and/or cooling layer and air-penetrable layer in an appropriately simple manner to the installation space within which the heating and/or cooling device or the entire air supply device is to be disposed.

A particularly high heating output of the heating layer or cooling output of the cooling layer can be achieved if there is assigned a well heat-conducting or cold-conducting cover layer, by which the generated heat/cold is distributed evenly within the heating or cooling layer. In particular, a metal foil or a sheet metal, for example of an aluminum or copper alloy, has proved suitable in this regard.

A particularly effective sandwich of the heating and/or cooling device is created by the provision of at least three air-penetrable layers, wherein a heating or cooling layer is respectively disposed between the middle and the outer air-penetrable layers. The middle air-penetrable layer is thus supplied with heat or cold by both these flanking heating or cooling layers, so that the air current flowing through the middle layer can be warmed or cooled particularly quickly. The two outer air-penetrable layers are consequently supplied with heat or cold only by the adjacent heating or cooling layer, so that in this region a lesser warming or cooling of the air current flowing through these is obtained. It is thereby ensured, inter alia, that no overheating of the structural parts surrounding this sandwich, such as, for example, a housing component or other parts contiguous thereto, occurs.

Different flow resistances are formed by combining a plurality of layers into a sandwich, with the layers varying, for example, by the distancing and orientation of the individual spacer webs, wires or threads. It can thus be achieved, for example by an appropriately more finely meshed knitted or woven fabric or the like of the middle of the three air-penetrable layers, that the air current flowing through this remains there longer than in the two outer layers.

In a further preferred embodiment, a centrally disposed air-penetrable layer is surrounded on the peripheral side by a heating layer. A particularly quick and homogenous warming or cooling of the through-flowing air current is thereby obtained. On the peripheral side of the heating layer, a further air-penetrable layer can here be provided, in which case the central layer is more strongly warmed or cooled by flowing air current than is the air current flowing through the layer on the peripheral side. This structure allows an air current which can be warmed or cooled very quickly and strongly in the central air-penetrable layer, while the air current making its way through the outer air-penetrable layer on the peripheral side stays cooler or warmer to prevent the contiguous structural parts, such as, for example, a housing wall, from being overheated or overcooled. It is clear that such a centrically structured arrangement of air-penetrable layers with possibly interposed heating or cooling layers can be optionally extended. In addition, both circular and oval or similar arrangements of the heating and cooling layers are conceivable.

In a preferred embodiment, a restrictor capable of defining flow blockage is provided downstream of the sandwich layers. The restrictor is in this case disposed fully inside the air duct in the region of the sandwich. With the aid of this restrictor, which can be configured as a grille or aperture plate, the air flow is slowed and regularized. This leads to a more uniform air flow and hence to an improved efficiency of the heating and/or cooling apparatus.

Other objects, advantages and novel features of the present invention will become apparent from the following detailed description of the invention when considered in conjunction with the accompanying drawings.

### BRIEF DESCRIPTION OF THE DRAWINGS

FIGS. 1a and 1b, respectively, show a schematic perspective view of a motor vehicle seat, within which an air supply device according to the invention is integrated;

FIG. 2 shows a schematic sectional view of the heating and/or cooling device of the air supply device, the sandwich of which consists of two heating or cooling layers disposed between three air-penetrable layers;

FIG. 3 shows a schematic sectional view of the sandwich, in which an optionally extendable plurality of air-penetrable layers are respectively separated from one another by a heating or cooling layer;

FIG. 4 shows a schematic perspective view of the sandwich of air-penetrable layer and heating and/or cooling layer, which sandwich is wound substantially in the shape of a worm and is disposed within the air duct of the air supply device;

FIGS. 5 and 6 show, respectively, a schematic cross section through the circular or oval sandwich, in which a central air-penetrable layer is surrounded on the peripheral side by a heating or cooling layer and by a further air-penetrable layer;

FIGS. 7a and 7b show, respectively, a top view of and a sectional view along the line VIIb-VIIb in FIG. 7a through the structure of the air-penetrable layer according to a first embodiment;

FIGS. 8a and 8b show, respectively, a top view of and a sectional view along the line VIIIb-VIIIb in FIG. 8a through the structure of the air-penetrable layer according to a second embodiment;

FIGS. 9a and 9b show, respectively, a schematic top view of and a sectional view along the line IXb-IXb in FIG. 9a through the structure of the air-penetrable layer according to a third embodiment;

FIG. 10 shows a schematic top view of the structure of the air-penetrable layer according to a fourth embodiment; and

FIGS. 11a and 11b show, respectively, a schematic top view of and a sectional view along the line XIb-XIb in FIG. 11a through the structure of the air-penetrable layer according to a fifth embodiment.

### DETAILED DESCRIPTION OF THE DRAWINGS

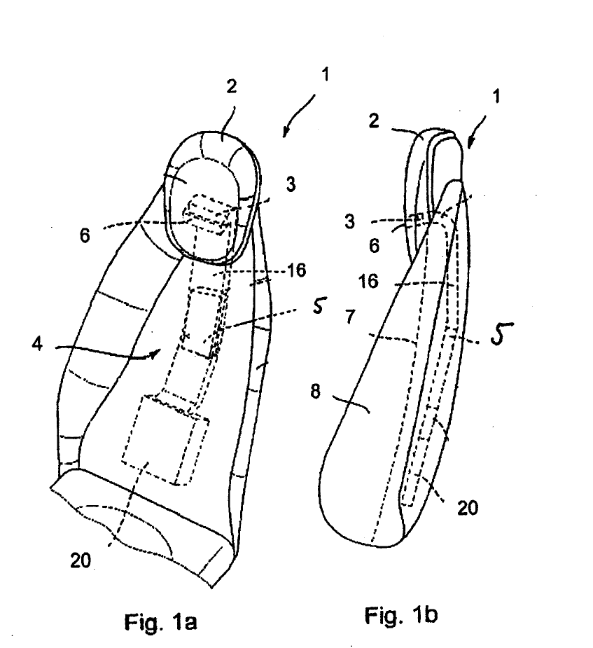

In FIGS. 1a and 1b, the backrest 1 of an automobile seat is indicated respectively in schematic perspective front view and in schematic side view. To the backrest 1 there is assigned a headrest 2. The automobile seat is here configured as an integral seat, the headrest 2 being disposed in overlapping contact with the backrest 1, in front of the latter. The headrest 2 is height-adjustable relative to the backrest 1 by means of guide means (not shown). Within the backrest 1 an air supply device 4 is fastened, which comprises, as the basic structural parts, a fan 20 (indicated schematically) at the lower end of the air supply device 4 and an air duct 16 disposed above the fan 20. Within the air duct 16, at a distance above and on the pressure side of the fan 20, a heating and/or cooling device 5 is provided, indicated in FIG. 1a merely in dashed representation, with which the air current generated by the fan 20 can be warmed in a manner explained in greater detail below. At the upper end, the vertically running air duct 16 is angled off forward in an L-shape and ends at an air outflow opening 6. Close to the air outflow opening 6, within the air duct 16, a grille element 3 is indicated. The grille element 3 is configured as a restrictor and ensures an additional homogenization and regularization of the air current flowing out of the sandwich 18. Furthermore, the grille element 3 generates a dynamic pressure, so that the air current flowing through heating and/or cooling device 5 remains longer within the sandwich 18 and thus can be better warmed or cooled. In FIG. 1b, a side cheek 8 of the backrest 1 and—indicated in dashed representation—the course of the upholstery cover 7 in the central mirror region of the backrest 1 is discernible. It hereby also becomes discernible that the air supply device 4 is disposed fully within the backrest 1 and only the air outflow opening 6 is visible from the outside. The air supply device 4 is formed in the present case as a preassembled installation module, which can be integrated into the vehicle seat and can be fastened to the backrest frame (not shown) of the seat. Likewise, it is also conceivable, however, for the air supply device 4 to be fitted, for example mounted, on the rear side of the backrest 2 as a retrofittable module. In the present illustrative embodiment, the fan 20 discernible at the lower end of the air supply device 16 has a non-discernible inlet opening, disposed on the rear side of the backrest 1. In the illustrative embodiment which is shown here, the air duct 16 consists of a plastic. The housing of the fan 20 is here configured in one piece with the air duct 16.

By means of the air supply device 4, the head, neck and shoulder region of the seat occupant can be subjected to a warm and/or cool air current, according to choice. In open travel, the air flowing over or around the windscreen creates in a known manner a so-called air roll in the region behind the vehicle seats, which air roll leads to undesirable draft phenomena in the region of the head, neck and shoulder region of the seat occupant. In order to significantly minimize these draft phenomena, the warm air current generated by the air supply device 4 is directed to the appropriate body region of the seat occupant. The warm air then flows around the seat occupant so as to achieve the desired warming of the head, neck and shoulder region. For cooling at particularly warm temperatures, cooled air can also conversely be used.

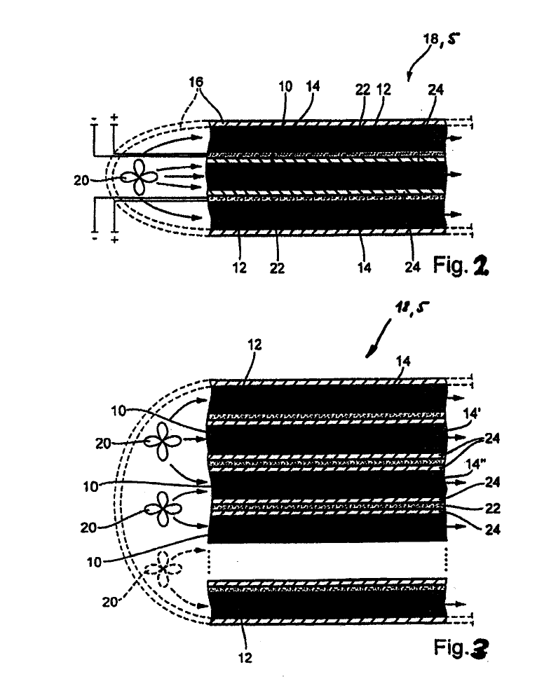

In FIG. 2, the heating and/or cooling device 5 of the air supply device 4, together with the associated fan 20, is represented. In the heating and/or cooling device 5, a middle air-penetrable layer 10 and two outer air-penetrable layers 12 are provided, which are combined with two heating and/or cooling layers 14, described in greater detail below, to form a sandwich 18. The sandwich 18 is here disposed within the air duct 16 shown merely schematically and in abstract representation.

Viewed in cross section, the sandwich 5 here occupies at least approximately the whole of the cross section of the air duct 16. Within the air duct 16, the fan 20 is also indicated, by means of which the air is conveyed, in particular, from the region behind the vehicle seat through the sandwich 18 in a manner described in greater detail below. In the present illustrative embodiment, the heating and/or cooling device 5 and the sandwich 18 and the air duct 16, respectively, are of roughly rectangular configuration in cross section.

The heating and/or cooling device 14 disposed between the middle air-penetrable layer 10 and the respectively assigned outer air-penetrable layer 12 comprises resistance heating elements, Peltier elements or the like, which can respectively be supplied with electric current, and is in the present case configured as a thin-layered, deformable and elastic stratum 22. To the two heating layers 14 there is respectively assigned a well heat-conducting or cold-conducting cover layer 24, which cover layers respectively adjoin the broad side of the middle air-penetrable layer 10 and, in the shown illustrative embodiment, are made from a well conducting metal foil or a sheet metal, in particular from an aluminum or copper alloy. In the present illustrative embodiment, all layers 10, 12, 14, 22 and 24 are configured flat and closely spaced.

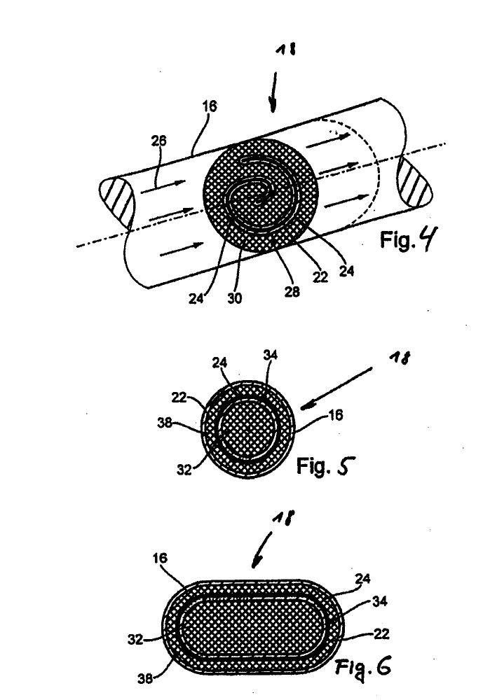

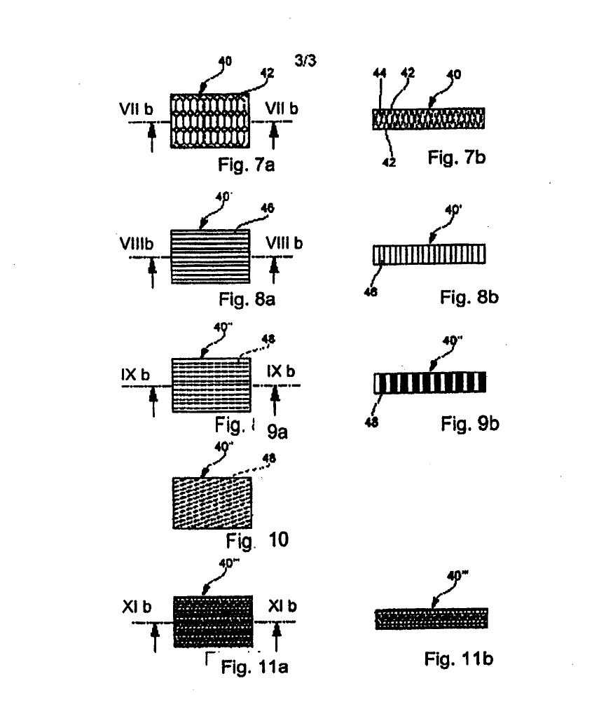

If an air current is generated by the fan 20 mounted upstream of the sandwich 18, then this air current makes its way via the respective narrow side into the middle air-penetrable layer 10 and into the two outer air-penetrable layers 12. In the present illustrative embodiment, the three air-penetrable layers 10, 12 are made from a spacer knitted fabric, described in greater detail below with reference to FIGS. 7a and 7b, consisting of a multiplicity of spacer threads or spacer webs. The spacer threads or spacer webs here run substantially transversely to the flow direction of the air current or transversely to the broad sides of the air-penetrable layers 10, 12. Instead of a spacer knitted fabric of this type, a woven fabric made from a multiplicity of spacer threads, a braided fabric or a wool-like formation can also, of course, be used. In other words, the spacer webs or the spacer threads can be disposed in mutually orientated arrangement, or else—as normally with wool—haphazardly relative to one another. An air current generated by the fan 20 is hence deflected correspondingly frequently at the spacer threads or the spacer webs as it flows through the respective air-penetrable layer 10, 12 and, after just a short distance, a turbulent diffuse flow is established within the respective air-penetrable layer 10, 12. Compared with a laminar flow, this diffuse flow generated by means of the spacer threads or spacer webs remains longer within the associated air-penetrable layer 10, 12 and can consequently absorb more heat (or cold in the case of a cooling layer 14) via the heating element 14—consisting of the resistance heating stratum 22 and the cover layer 24. The diffuse distribution of the air current within the respective air-penetrable layer 10, 12 additionally causes individual boundary layers to come into contact with the respective heating layer 14, and also produces a good and homogenous mixing of the air flow.

Since the middle air-penetrable layer 10 is bounded on its two broad sides by, respectively, a heating layer 14 and a cover layer 24, the air current making its way through the middle air-penetrable layer 10 is particularly strongly warmed (or cooled in the case of a cooling layer 14). Owing to the fact that the two outer air-penetrable layers 12 respectively come into contact with the heating layer 14, or the resistance heating stratum 22 thereof, only on their broad side facing the middle layer 10, the two air currents making their way through the respectively outer air-penetrable layer 12 are less strongly warmed (or, in the case of a cooling layer 14, less strongly cooled) than the air current making its way through the middle air-penetrable layer 10. It is thereby ensured, inter alia, that the wall of the air duct 16 cannot be overheated by high temperatures of the air currents making their way through the outer air-penetrable layers 12. In other words, the two partial air currents flowing through the outer air-penetrable layers 12 act as a type of heat insulator for the central, warmer partial air current.

In the present illustrative embodiment, the middle air-penetrable layer 10 additionally has a higher flow resistance than the two outer air-penetrable layers 12 which flank it. The higher flow resistance is obtained by the fact that the spacer threads or the spacer webs of the middle air-penetrable layer 10 are arranged closer together and thus the knitted or woven fabric is formed more closely meshed or denser overall than the structure of the two outer air-penetrable layers 12. The effect of this—given the same entry velocity of all air currents on the inlet side of the air-penetrable layers 10, 12—is that the partial air current through the middle layer 10 flows through this more slowly than the two partial air currents which make their way through the two outer layers 12. As a result of different velocities, a greater or lesser amount of heat (or cold in the case of a cooling layer 14) can consequently be absorbed by the individual air currents. Moreover, on the outlet side, a possibly desired stratification of the total air current can be achieved, namely with a middle, warmer air current from the middle layer 10 and two outer, somewhat less warm air currents from the outer layers 12.

FIG. 3 shows in schematic sectional view the heating and/or cooling device 5 according to a second embodiment, in which the sandwich 18 comprises a plurality of air-penetrable layers 10, 12 and heating or cooling layers 14. As indicated in dashed representation, the sandwich 18 can here be supplemented by one or more middle air-penetrable layers 10 and is thus variable in its thickness. In the embodiment which is shown here, three middle air-conducting layers 10 and, on the outer side, respectively an outer air-penetrable layer 12 are arranged, at least one heating and/or cooling layer 14 being respectively provided between the individual air-penetrable layers 10, 12. The sandwich 18 is here, in turn, disposed within an air duct 16, and in the present illustrative embodiment is placed downstream of a plurality of fans 20. While in FIG. 3 the uppermost heating layer 14 is identical to the uppermost heating layer 14 according to FIG. 2, the second uppermost and third uppermost heating layer 14′, 14″, viewed from above, have a respectively different structure. In the case of the second uppermost heating layer 14′, directly adjacent to the above-situated or below-situated air-penetrable middle layer 10, a cover layer 24 is respectively provided, which, in turn, is made from a well heat-conducting sheet metal or a metal foil. To each of the two cover layers 24 there is respectively assigned a resistance heating stratum 22, as these have already been described with reference to FIG. 2. From this structure of the second uppermost heating layer 14′, the structure of the third uppermost heating layer 14″ differs by the fact that, instead of two resistance heating strata 22, only one is disposed between the two cover layers 24 and thus heats these two cover layers 24. With respect to the working method of the heating device 5 according to FIG. 3, reference is made to the working method of the heating device 5 according to FIG. 2, which, is different due to the different number of air-penetrable layers 10 used or the different number of assigned heating layers 14.

FIG. 4 shows in schematic perspective representation the heating device 5 according to a third embodiment, which is disposed within a tubular air duct 16. Within the air duct 16, upstream of the sandwich 18, a fan (not represented) is provided, by which an air current represented with arrows 26 is generated. The sandwich 18 essentially consists of a heating layer 28 and an air-penetrable layer 30 and is wound into a worm of roughly circular cross section. The air-penetrable layer 30 is here configured such that this fully encloses the heating layer 28 on the peripheral side. The heating layer 28, in turn, consists of a resistance heating stratum 22, which on its two broad sides is covered by a respective cover layer 24, preferably made of a metal foil or a sheet metal. It can be seen that, here too, central portions of the air-penetrable layer 30 are flanked on their two broad sides by the heating layer 28. Consequently, in these regions, a strong heating of the air current is possible. In contrast, the peripherally outer portions of the air-penetrable layer 30, or the portions thereof contiguous to the wall of the air duct 16, are flanked by the heating layer 28 only on one—namely the inner—broad side. Accordingly, that part of the air current which flows through the outer regions of the air-penetrable layer 30 which are contiguous to the wall of the air duct 16 is less strongly warmed than the previously described inner parts of the total air current. As a result, a stratification of the total air current—viewed in cross section—is also herewith created, wherein a central partial air current is more strongly warmed than an outer part of the air current. It is clear that the air-penetrable layer 30 can also comprise a plurality of portions which have a different flow resistance. Furthermore, instead of or in addition to the heating layer 28, a cooling layer can also here be provided.

In FIG. 5, in a schematic cross-sectional view, the heating device 5 according to a fourth embodiment is shown, in which the sandwich 18 is disposed within a housing configured as a tubular air duct 16. The sandwich 18 here comprises a central air-penetrable layer 32, of roughly circular cross section overall, which is surrounded on the peripheral side by a heating layer 34. The heating layer 34 comprises a metal-plate or metal-foil cover layer 24, which adjoins the outer envelope side of the air-penetrable layer 32 and which, in turn, is enclosed on the outer side by a resistance heating stratum 22. On the outer peripheral side of the heating layer 34, an outer air-penetrable layer 38 is provided, which runs between the heating layer 34 and the wall of the air duct 16. Here, too, it can be seen that the centrally disposed air-penetrable layer 32 can be more strongly warmed than the outer air-penetrable layer 38. Also, the central air-penetrable layer 32 and the outer air-penetrable layer 38 can offer a different flow resistance for the through-flowing air current.

In FIG. 6, the heating device 5 according to FIG. 5 is represented according to a further embodiment, which differs from the embodiment according to FIG. 6a merely by the fact that, in the present case, an oval cross section of the sandwich 18 has been chosen. The sandwich 18 according to FIGS. 5 and 6 can be optionally radially extended, according to the diameter of the air duct 16. The sandwich 18 can also be optionally formed in terms of its length.

In FIGS. 7a and 7b, a possible structure 40 of the air-penetrable layers 10, 12, 30, 32, 38 is represented respectively in schematic top view and in schematic sectional view along the line VIIb-VIIb in FIG. 7a. The structure 40 here consists of so-called spacer knitted fabric, which on the upper and lower broad side of said structure, respectively comprises a cover layer in the form of a honeycomb structure 42. Extending between the upper and lower cover layer 42 are a multiplicity of spacer threads or spacer webs 44, which extend substantially transversely to the two cover layers 42. As a result of the mutual orientation and distancing of the spacer threads or spacer webs 42, the flow resistance of the structure 40 can here be varied and consequently the flow velocity of the air current making its way through the structure 40 can be adjusted. In the present illustrative embodiment, the spacer threads or spacer webs 44 can be made, in particular, from a plastic. In one particular embodiment, instead of the spacer threads or spacer webs 44, spacer wires or the like are used, which are preferably made from a well heat-conducting metal such as from an aluminum alloy or a copper alloy. Metal wires of this type have the advantage over plastics threads that they can additionally warm the heat or cold—generated by means of the heating and/or cooling layer 14, 28, 34—particularly well from the turbulent or diffuse flow of the air current making its way through the air-penetrable layer 10, 12, 30, 32, 38.

In FIGS. 8a and 8b, the structure 40′ of the air-penetrable layers 10, 12, 30, 32, 38 is represented respectively in schematic top view and in schematic layered view along the line VIIIb-VIIIb in FIG. 8a, according to a further embodiment. Spacer webs or spacer wires 46 here run perpendicular to the two broad sides of the structure 40′. The spacer webs or spacer wires 46 are here—as is discernible from FIG. 8a—arranged in a row.

In FIGS. 9a and 9b, there is represented respectively in schematic top view and in schematic sectional view along the line IXb-IXb in FIG. 9a a further structure 40″, in which spacer webs 48 of substantially rectangular cross section extend between the two broad sides of the structure 40. As viewed together with FIG. 10, which in top view shows the arrangement of the spacer webs 48 in an alternative configuration, it becomes apparent that the webs can be aligned along, transversely to or else obliquely to the flow direction of the air current flowing through the air-penetrable layer.

FIGS. 11a and 11b further show respectively in schematic top view and in sectional view along the line XIb-XIb in FIG. 11a a structure 40″′, in which the spacer threads, spacer webs or spacer wires are aligned in mutually non-orientated arrangement in the manner of a wool. The spacer threads, spacer webs or spacer wires can here be made, in particular, from a plastic or else from a metal.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-23. (canceled)

24. A motor vehicle seat comprising:
an air supply device for supplying the head, neck and shoulder region of a seat occupant with an air current which can issue from an air outflow opening,
wherein the air supply device comprises at least one of a heating device for warming the air current or a cooling device for cooling the air current,
wherein the heating or cooling device comprises a sandwich having at least one of a heating or cooling layer and at least one air-penetrable layer, the air-penetrable layer having a means for converting the air current into a turbulent or diffuse flow.

25. The motor vehicle seat as claimed in claim 24, wherein a restrictor is downstream of the sandwich for the homogenization of the air current leaving the sandwich.

26. The motor vehicle seat as claimed in claim 24, wherein the structure of the air-penetrable layer comprises a multiplicity of spacer threads, webs, or wires.

27. The motor vehicle seat as claimed in claim 24, wherein the structure of the air-penetrable layer is formed from a knitted fabric.

28. The motor vehicle seat as claimed in claim 24, wherein the structure of the air-penetrable layer is formed from a woven fabric.

29. The motor vehicle seat as claimed in claim 24, wherein the structure of the air-penetrable layer is formed from a braided fabric.

30. The motor vehicle seat as claimed in claim 24, wherein the structure of the air-penetrable layer is haphazardly formed in the manner of a wool.

31. The motor vehicle seat as claimed in claim 24, wherein the air-penetrable layer is bounded on its two broad sides by a respective cover layer.

32. The motor vehicle seat as claimed in claim 31, wherein the two cover layers have essentially a honeycomb structure.

33. The motor vehicle seat as claimed in claim 24, wherein the structure of the air-penetrable layer is made from a plastic.

34. The motor vehicle seat as claimed in claim 24, wherein the structure of the air-penetrable layer is made from a well heat-conducting or cold-conducting metal.

35. The motor vehicle seat as claimed in claim 24, wherein the structure of the air-penetrable layer is configured such that it is easily deformable.

36. The motor vehicle seat as claimed in claim 24, wherein the heating layer is assigned a well heat-conducting cover layer or the cooling layer is assigned a well cold-conducting cover layer, which conducting layer is disposed between the heating or cooling layer and the air-penetrable layer.

37. The motor vehicle seat as claimed in claim 24, wherein at least three air-penetrable layers are provided with a heating or cooling layer respectively being disposed between the middle and the outer air-penetrable layers.

38. The motor vehicle seat as claimed in claim 37, wherein the structure of the air-penetrable middle layer has a higher flow resistance than the structure of the air-penetrable outer layers.

39. The motor vehicle seat as claimed in claim 24, wherein the sandwich of air-penetrable layer and the heating or cooling layer is wound substantially in the shape of a worm.

40. The motor vehicle seat as claimed in claim 24, wherein the air-penetrable layer is surrounded on the peripheral side by the heating or cooling layer.

41. The motor vehicle seat as claimed in claim 40, wherein the heating or cooling layer is surrounded on the peripheral side by a further air-penetrable layer.

42. The motor vehicle seat as claimed in claim 41, wherein the structure of the air-penetrable inner layer has a higher flow resistance than the structure of the air-penetrable peripheral outer layer.

43. The motor vehicle seat as claimed in claim 24, wherein the air outlet opening is covered by an outlet grille or mesh.

44. The motor vehicle seat as claimed in claim 24, wherein the air supply device can be fitted on the backrest as a retro-fittable module.

45. The motor vehicle seat as claimed in claim 24, wherein the air supply device can be integrated into the vehicle seat as a preassembled installation module.

46. The motor vehicle seat as claimed in claim 24, wherein the sandwich is disposed within an air duct of the air supply device, and the sandwich, when viewed in cross section, occupies at least approximately the whole of the cross section of the air duct.
